(19) United States
(12) Patent Application Publication
(10) Pub. No.: US 2008/0016983 A1
(43) Pub. Date: Jan. 24, 2008

(54) Intermediate Flange for a Machine Tool

(76) Inventor: Dietmar Saur, Gomaringen (DE)

Correspondence Address: MICHAEL J. STRIKER, 103 EAST NECK ROAD, HUNTINGTON, NY, 11743, US

(21) Appl. No.: 11/579,313

(22) PCT Filed: Jun. 20, 2005
(86) PCT No.: PCT/EP05/52849

§ 371 Date: Nov. 1, 2006

(30) Foreign Application Priority Data
Jul. 28, 2004 (DE) 10 2004 036 585.7

(51) Int. Cl. B25F 5/02; F16H 21/12

(52) U.S. Cl. 74/813 R; 74/1 R

(57) ABSTRACT

The invention relates to an intermediate flange for a machine tool, which serves to support machine parts and includes an outer wall (22).

According to the invention, the outer wall (22) has a latticed support structure (10), which provides the inventive intermediate flange with good torsional and bending resistance while requiring only a small amount of material. The latticed support structure (10) can have a preferably honeycomb or diamond-shaped design with solid, intersecting segments (11).

### RELATED ART

The present invention relates to an intermediate flange for a machine tool, which serves to support machine parts, according to the preamble of claim 1.

Components designed as an intermediate flange for a machine tool, in particular for rotary and/or chisel hammers with a pistol-shaped design, which serve to support impact-mechanism parts and/or the motor axis are generally known. The intermediate flange is preferably composed of a heat-conducting material, e.g., an aluminium alloy, magnesium etc., and provides mechanical strength at a relatively high working temperature. This design simultaneously allows heat to be removed from the gearbox area and dissipated by the cooling air of the motor. The design required for this is relatively complex. In addition, the conventional design is manufactured using pressure diecasting, with the objective of attaining a constant wall thickness. The wall thickness of the conventional design is defined by the most highly stressed region, which results in unnecessary use of material. The disadvantageous consequence of this is a relatively complex and heavy design.

### ADVANTAGES OF THE INVENTION

It is provided that the inventive intermediate flange includes an outer wall with a latticed support structure. Advantageously, only a small amount of material is used. At the same time, the weight of the intermediate flange can be reduced. The support structure can be formed by solid, intersecting segments. The results in good torsional and bending resistance. A loadable design with high performance, coupled with a reduction in weight and good thermal conductivity can be provided.

In a particularly advantageous embodiment, the inventive intermediate flange includes an outer wall with a honeycomb and/or diamond-shaped design, by way of which the amount of material used can be advantageously reduced. Depending on the application and product type, the honeycomb or diamond-shaped design can be irregular. This design is suited, in particular, to be manufactured using casting methods; the segments can serve as casting channels. Depending on the requirements, the stiffness of the component can be influenced by the height of the segments.

To create a reliable casting process for the inventive intermediate flange, a region located between the segments in the structure can be filled with material. Although this is not required for strength, it simplifies the manufacture of the components. The material-filled region preferably has thinner walls than the segments, to reduce the weight further. In all, the inventive design results in great strength while using a small amount of material, and it is low-weight. As an alternative, cavities can be formed between the segments.

It can be provided that cavities are formed between the material-filled region and the segments. As a result, the outer wall of the inventive intermediate flange forms the largest possible surface, by way of which more heat can be favorably removed from the gearbox region than would be possible with a flat outer wall surface. An optimal cooling effect is attained as a result.

With the inventive intermediate flange it is also advantageously possible to locate different bearing points in one component. It can be provided that the support structure is located between at least two diametrically opposed end faces, which can include a bearing point for an armature of an electric drive motor, and/or a drive-end bearing, and/or a bearing point for locking sleeves. The bearing point for the armature and a centering opening for the motor housing can be located in an end-face region, and they can be coaxial with each other. They are located in a “plane”, so to speak, in which a seal which contains the necessary lubricant and seals off the gearbox can also be located.

The bearing for a locking sleeve and/or the bearing point for a drive-end bearing can be located on the end face on the gearbox side of the intermediate flange, i.e., the second end face, which is diametrically opposed to the other end face. The locking sleeve preferably requires a stable support and connection in order to absorb and dampen the forces produced when the machine tool is used. These forces are, e.g., the force applied by the operator, the supporting forces from the impact mechanism, and the torque and leverage introduced by the tool into the machine. As a result of the honeycomb and/or diamond-shaped design of the inventive intermediate flange, a component stiffness can be attained that fulfills these requirements.

In a particularly preferred embodiment, the support of the locking sleeve can be tubular in design, and the bearing point for the drive-end bearing can be located on a third, laterally displaced end face. This embodiment is suited, in particular, for use with machine tools which have a pistol-shaped design, for reasons related to installation space. The drive-end bearing can be designed as a wobble bearing for an impact mechanism. It can also be provided, however, that an intermediate shaft required for the wobble bearing is supported in the inventive intermediate flange. A ball bearing, in particular, can be provided to absorb the radial load which results. This bearing can also be designed as a bearing seat, and it can simultaneously support the first gear stage (armature speed/impact rate). This bearing point can advantageously absorb the transmitted torques and forces, and the reaction forces from the impact mechanism.

### DRAWING

Further embodiments, aspects and advantages of the present invention also result independently of their wording in the claims, without limitation to generality, from an exemplary embodiment of the present invention presented below with reference to the drawing.

FIG. 1 shows a perspective view of an exemplary embodiment of an inventive intermediate flange; and

FIG. 2 shows the exemplary embodiment in FIG. 1, from a different perspective.

### DETAILED DESCRIPTION OF THE EXEMPLARY EMBODIMENT

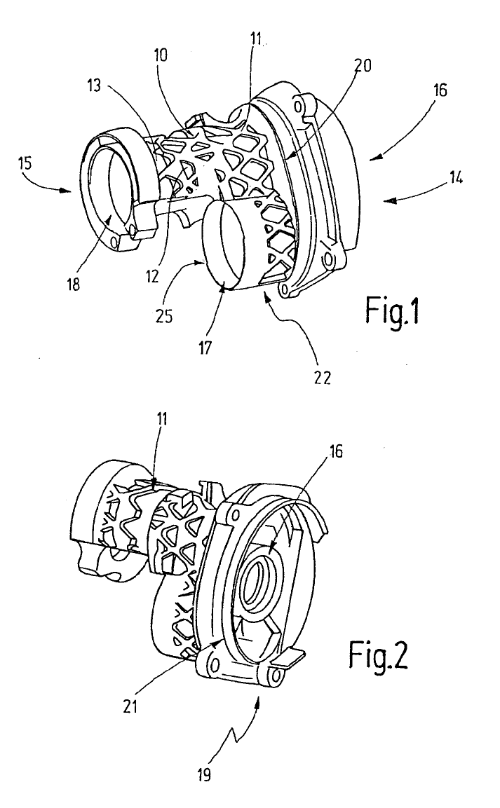

FIG. 1 shows a perspective view of an exemplary embodiment of an inventive intermediate flange for a machine tool, which, in the assembled state, is located in a not-shown housing, in which a not-shown drive motor—in particular an electric motor—a gearbox, and an impact mechanism are also located. The intermediate flange has an outer wall 22, which has a latticed support structure 10 with a regular, diamond-shaped design. Support structure 10 is formed by solid, intersecting segments 11. Regions 12 located between segments 11 of the structure are filled with material. Material-filled regions 12 have thinner walls than do segments 11. For simplicity, only one of the segments 11 and one of the regions 12 are labeled with a reference numeral. Outwardly-open cavities 13 are located between material-filled regions 12 and individual segments 11; this results in the surface structure which is typical for the inventive intermediate flange. This results in good torsional and bending resistance while requiring only a small amount of material and resulting in a low component weight. The large surface of the outer wall is also suited for absorbing heat; this results in a particularly favorable cooling effect.

Support structure 10 is located between a first end face 14 and two end faces 15, 25, which are diametrically opposed to first end face 14. End face 14 includes a bearing point 16 (which is not shown in FIG. 1) for an armature of an electric motor. A circumferential sealing groove 20 which serves to accommodate a seal is located on the side facing first end face 14. Sealing groove 20 is shown in FIG. 1, but the seal is not.

Second end face 15 is located on the gearbox-side on the side of the intermediate flange which is diametrically opposed to first end face 14, and it includes a bearing point for a locking sleeve. Bearing point 18 is designed as a tube in the direction toward a not-shown hammer tube of an impact mechanism. Bearing point 18 is connected via intersecting segments 11 with the body of the intermediate flange. A third end face 25 with a drive-end bearing 17 is located on the same side as second end face 15; third end face 25 is laterally displaced and is located underneath, relative to the installation position.

FIG. 2 shows the exemplary embodiment of the inventive intermediate flange in FIG. 1 in a different perspective. It shows a view of first end face 14 and bearing point 16 for the armature. A centering opening 21 for a not-shown motor housing is formed in the same end-face region 19 as bearing point 16 for the armature. They are coaxial relative to each other and are located in a “plane”.

What is claimed is:

1. An intermediate flange for a machine tool, which serves to support machine parts and includes an outer wall (22),
wherein
the outer wall (22) has a latticed support structure (10).

2. The intermediate flange as recited in claim 2,
wherein
the support structure (10) is formed by intersecting segments (11).

3. The intermediate flange as recited in one of the claim 1,
wherein
the support structure (10) has a honeycomb or diamond-shaped design.

4. The intermediate flange as recited in claim 3,
wherein
the honeycomb or diamond-shaped design is irregular.

5. The intermediate flange as recited in one of the claim 1, wherein
a region (12) located between the segments (11) in the structure is filled with material.

6. The intermediate flange as recited in claim 5,
wherein
the material-filled region (12) has thinner walls than the segments (11).

7. The intermediate flange as recited in claim 1, wherein
cavities (13) are located between the material-filled region (12) and the segments (11).

8. The intermediate flange as recited in claim 1,
wherein
the support structure (10) is located between at least two diametrically opposed end faces (14, 15).

9. The intermediate flange as recited in claim 1, wherein
one of the end faces (14, 15) includes a bearing point (16) for an armature of an electric drive motor and/or a drive-end bearing (17) and/or a bearing (18) for locking sleeves.

10. The intermediate flange as recited in claim 1, wherein
the bearing point (16) of the armature and a centering opening (21) for a motor housing are located in an end-face region (19).

11. The intermediate flange as recited in claim 10,
wherein
the end-face region (19) includes a sealing groove (20) for sealing off the gearbox.

12. A machine tool with an intermediate flange as recited in claim 1.
